(19) United States
(12) Patent Application Publication
(10) Pub. No.: US 2002/0168211 A1
(43) Pub. Date: Nov. 14, 2002

(54) Intermediate transfer type printer equipped with mounting tray for mounting recording medium

(75) Inventors: Masashi Ogasawara, Iwate-ken (JP); Koichi Sugiyama, Iwate-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 10/144,221

(22) Filed: May 10, 2002

(30) Foreign Application Priority Data
May 14, 2001 (JP) 2001-143451
May 14, 2001 (JP) 2001-143452

(51) Int. Cl. B41J 2/325; B41J 15/02

(52) U.S. Cl. 400/613

(57) ABSTRACT

When a primary image recorded on an intermediate transfer body is retransferred onto a recording medium such as CD to record an image, the recording medium can be easily taken out of a mounting tray; in order to record a satisfactory image on the recording medium, on a downstream side of a recording head in a conveying path of the intermediate transfer body, there is arranged a mounting tray for mounting the recording medium so as to oppose to a heat roller through the intermediate transfer body; of a surface of the mounting tray, a surface of a mounting portion for mounting the recording medium is made into a non-sticking surface which when the heat roller is press-contacted to the recording medium through the intermediate transfer body, prevents the recording medium from strongly sticking to the mounting portion; in a surrounding portion of the mounting portion, there is formed a holding member for holding an outer peripheral surface of the recording medium; and a surface of a holding member is made flush with a surface of the recording medium mounted on the mounting portion.

### BACKGROUND OF THE INVENTION

1. Field of the Invention

The present invention relates to an intermediate transfer type printer, and more particularly to an intermediate transfer type printer which achieves printing on a printing medium having a thickness dimension as compared with a general sheet, for being conveyed by a recording medium conveying device.

2. Description of the Prior Art

Conventionally, a printer which achieves recording through the use of an intermediate transfer method is known as image recording means.

This printer has an ink ribbon to be conveyed between a recording head and a platen roller, and an intermediate transfer sheet as an intermediate transfer body. On the downstream side of the recording head in a conveying path of the intermediate transfer sheet, there is provided a transfer unit which retransfers, onto a recording medium, ink temporarily transferred onto the intermediate transfer sheet. Above the intermediate transfer sheet in this transfer unit, there is disposed a heat roller, and on the other hand, below the intermediate transfer sheet, a mounting tray which mounts the recording medium is disposed so as to be located to oppose to the heat roller. Also, this mounting tray is provided on the outside of the intermediate transfer type printer in such a manner as to be able to freely reciprocate between a position where the recording medium is mounted on the mounting tray and taken out and the transfer unit.

As regards a recording method of this printer, first the mounting tray is positioned on the outside of the intermediate transfer type printer. Next, the recording medium is adsorbed through the use of a recording medium conveying device separate from the intermediate transfer type printer, and the recording medium is conveyed to the mounting tray to be mounted thereon. Thereafter, the mounting tray is caused to move to the transfer unit. Next, the ink of the ink ribbon is temporarily transferred onto the intermediate transfer sheet, the intermediate transfer sheet is conveyed to the transfer unit, and the mounting tray with the recording medium mounted thereon is moved to the transfer unit. Thus, the heat roller heated is caused to descend, and this heat roller is first caused to press-contact one end of the recording medium through a portion of the intermediate transfer sheet with the ink transferred thereon. Next, the mounting tray is caused to move such that the entire recording medium press-contacts the heat roller. In this respect, the recording medium may be mounted on and taken out of the mounting tray manually.

Thus, the ink temporarily transferred onto the intermediate transfer sheet is caused to melt by means of the heat of the heat roller for retransferring it on the entire surface of the recording medium to achieve recording on the recording medium.

The inventors of the present invention developed a printer using an intermediate transfer method for achieving recording on a comparatively thick recording medium requiring attention in handling, such as CD (Compact Disk) like music CD and CD-ROM, and DVD (Digital Video Disk).

This intermediate transfer type printer moves the mounting tray on the outside of the intermediate transfer type printer to adsorb the recording medium on the mounting tray through the use of the recording medium conveying device or manually, whereby the recording medium is taken out of the intermediate transfer type printer.

When, however, press-contacting the retransfer roller to the recording medium in order to retransfer, onto a recording medium, the ink temporarily transferred onto the intermediate transfer sheet, a strong force is applied to the recording medium by means of the retransfer roller, and therefore, the recording medium may stick to the mounting tray. In such a case, even if the recording medium is adsorbed in order to take the recording medium out of the mounting tray through the use of the recording medium conveying device, the recording medium cannot be reliably taken out of the mounting tray. For this reason, it takes time to take the recording medium out of the mounting tray, and further, it is also conceivable to fail in taking out the recording medium to cause damage to the recording medium.

Also, when a recording medium such as CD described above is mounted on the mounting tray, between the surface of the mounting tray and the surface of the recording medium, there is caused a difference corresponding to the thickness dimension of the recording medium. Thus, when the heat roller is press-contacted to one end of the recording medium through the intermediate transfer sheet, since the recording medium is circular-shaped, only the center of the intermediate transfer sheet abuts upon the surface of the recording medium at the beginning, and on the other hand, both ends of the intermediate transfer sheet abut upon the surface of the mounting tray. For this reason, between a height position of the mounting tray upon which both ends of the intermediate transfer sheet abut and a height position of the recording medium upon which the center abuts, there is caused a difference, resulting in a difference in tension between the center and other portions of the intermediate transfer sheet. Therefore, when the heat roller is caused to move from one end of the recording medium toward the other end in this state, a wrinkle 31 occurs on the intermediate transfer sheet 30 as shown in FIG. 4. Thus, when the ink transferred onto the intermediate transfer sheet 30 is retransferred onto the recording medium 32 as it is, the ink is retransferred in a state in which the wrinkle 31 occurs also in the recording medium 32. As a result, a failure is caused in the retransfer of the ink onto the recording medium 32, and this leads to a problem that an image such as satisfactory characters cannot be recorded on the recording medium 32.

### SUMMARY OF THE INVENTION

The present invention has been achieved in views of these problems, and is aimed to provide an intermediate transfer type printer capable of easily taking, after recording is achieved on the recording medium, the recording medium out of the mounting tray through the use of a recording medium conveying device or manually.

Also, when recording is achieved on a recording medium which is not square-shaped but has a thickness dimension as compared with a sheet through the use of an intermediate transfer sheet, it is an object to provide an intermediate transfer type printer capable of recording a satisfactory image on the recording medium.

In order to achieve the object, according to the present invention, there is provided an intermediate transfer type printer having an intermediate transfer body in which ink of an ink ribbon is transferred by a recording head disposed so as to oppose to a platen to form a primary image, and a recording medium in which the primary image formed on the intermediate transfer body is retransferred to form a predetermined image, wherein on a downstream side of the recording head in a conveying path of the intermediate transfer body, there is arranged a mounting tray for mounting the recording medium so as to oppose to the intermediate transfer body, and of a surface of the mounting tray, a surface of a mounting portion for mounting the recording medium is made into a non-sticking surface which, when the intermediate transfer body is press-contacted to the recording medium, prevents the recording medium from sticking to the mounting portion.

According to the present invention, there is provided an intermediate transfer type printer, wherein even when the intermediate transfer body is press-contacted to the recording medium, there is no possibility that the recording medium strongly sticks to the mounting portion.

Also, according to the present invention, there is provided another intermediate transfer type printer, wherein the non-sticking surface is constructed by forming a fluoroplastic layer.

According to the present invention, there is provided an intermediate transfer type printer, wherein since a surface of fluoroplastic has a low coefficient of friction, even when the intermediate transfer body is press-contacted to the recording medium, there is no possibility that the recording medium strongly sticks on the mounting portion.

Further, according to the present invention, there is provided another intermediate transfer type printer, wherein the printer is constructed by forming the non-sticking surface with microscopic asperities.

According to the present invention, there is provided an intermediate transfer type printer, wherein since there exists air between the recording medium and the mounting portion, even when the intermediate transfer body is press-contacted to the recording medium, there is no possibility that the recording medium strongly sticks on the mounting portion.

Further, according to the present invention, there is provided another intermediate transfer type printer, wherein there is arranged an intermediate transfer sheet onto which ink of a recorded image is temporarily transferred through an ink ribbon by a recording head disposed so as to oppose to a platen; there is arranged a retransfer roller for retransferring, onto a recording medium, the ink transferred onto the intermediate transfer sheet; there is arranged a mounting tray which mounts the recording medium so as to oppose to the retransfer roller through the intermediate transfer sheet; of a surface of the mounting tray, in a surrounding portion of a portion for mounting the recording medium, there is formed a holding member for holding a peripheral edge of the recording medium; and the holding member is formed in such a manner that when the recording medium is mounted on the mounting tray, a surface of the recording medium is flush with a surface of the holding member.

According to the present invention, there is provided an intermediate transfer type printer, wherein since the retransfer roller abuts upon a surface of the recording medium and a surface of the holding member which become flush with a surface of the retransfer roller through the intermediate transfer sheet, there is no possibility that any excessive tension is applied to the intermediate transfer sheet.

Also, according to the present invention, there is provided another intermediate transfer type printer wherein on an under surface of the holding member, there is disposed an elastic member.

Also, according to the present invention, there is provided another intermediate transfer type printer wherein the retransfer roller softly abuts upon the surface of the recording medium and the surface of the holding member through the intermediate transfer sheet so that the position of the surface can be adjusted.

### BRIEF DESCRIPTION OF THE DRAWINGS

FIG. 1 is a conceptual view showing an intermediate transfer type printer according to the present invention;

FIG. 2 is a perspective view showing a conveying base and a mounting tray disposed on the intermediate transfer type printer shown in FIG. 1;

FIG. 3 is a cross-sectional view showing the conveying base and a mounting tray shown in FIG. 2; and

FIG. 4 is a conceptual view showing a case where the intermediate transfer sheet has become wrinkled when a recording medium is mounted on a mounting tray with no holding member disposed for achieving recording.

### DETAILED DESCRIPTION OF THE PREFERRED EMBODIMENTS

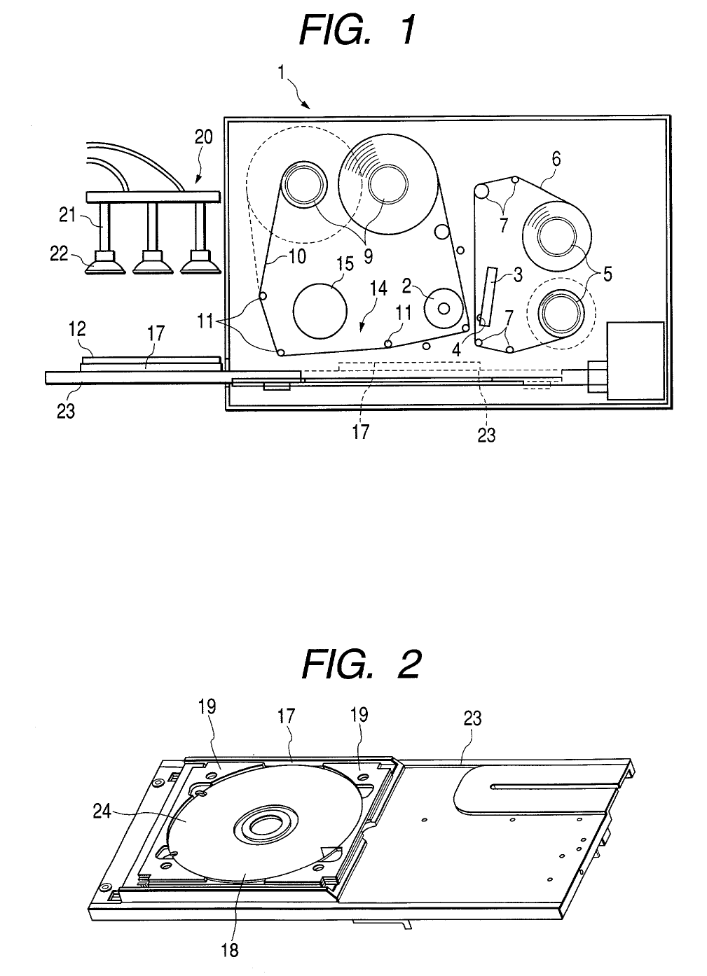

Hereinafter, with reference to FIGS. 1 and 2, the description will be made of an intermediate transfer type printer according to embodiments of the present invention.

FIG. 1 shows an intermediate transfer type printer according to the present embodiment, and on the intermediate transfer type printer 1, a cylindrical-shaped platen roller 2 is supported in such a manner as to be able to be freely rotationally driven as shown in FIG. 1. At a position opposite to the platen roller 2, a recording head 3 with a plurality of heater elements 4 orientated and arranged is disposed so as to be able to press-contact to the platen roller 2.

Also, on one side of the intermediate transfer type printer 1, there are provided a pair of ribbon rolls 5 around each of which an ink ribbon is wound. This ink ribbon 6 is adapted to be guided between the platen roller 2 and the recording head 3 while being supported by a plurality of rollers 7.

Further, on the upper side of the intermediate transfer type printer 1, there are provided a pair of sheet rolls 9 around each of which an intermediate transfer sheet 10 as an intermediate transfer body is wound. This intermediate transfer sheet 10 is taken out of one sheet roll 9, travels in the horizontal direction on the lower side of the intermediate transfer type printer 1 while it is being guided between the recording head 3 and the platen roller 2 supported by a plurality of rollers 11, and is guided on the upper side of the printer to be wound around the other sheet roll 9. On this intermediate transfer sheet 10, an image for achieving recording on the CD 12 as a recording medium is adapted to be transferred and recorded in ink of the ink ribbon 6 by means of the recording head 3.

Also, on the downstream side of the recording head in the conveying path of the intermediate transfer sheet 10, there is provided a transfer unit 14 for retransferring, onto the CD 12, the ink temporarily transferred onto the intermediate transfer sheet 10, and on the upper side of the intermediate transfer sheet 10 in this transfer unit 14, the heat roller 15 as a retransfer roller is disposed in such a manner as to be freely movable vertically.

Also, on the lower side of the transfer unit 14, there is disposed a conveying base 23 for conveying the recording medium (CD) 12, and on a nearly half of the upper surface of the conveying base, a mounting tray 17 for mounting the CD 12 is provided so as to oppose to the heat roller 15 through the intermediate transfer sheet 10. Thus, this conveying base 23 is adapted to be able to reciprocate between a position where the mounting tray 17 is exposed to the outside of the intermediate transfer type printer 1 and a position where one end of the CD 12 mounted on the mounting tray 15 toward the outside of the intermediate transfer type printer 1 press-contacts the heat roller 15.

Further, on the outside of the intermediate transfer type printer 1, at a position where the mounting tray 17 is exposed to the outside of the intermediate transfer type printer 1, there is provided a recording medium conveying device 20 for mounting the CD 12 on or taking out of the mounting tray 17. This recording medium conveying device 20 is capable of freely ascending and descending above the mounting tray 17 at a position where the mounting tray 17 is exposed to the outside of the intermediate transfer type printer 1. At the tip end of an arm 21 of the recording medium conveying device 20, there is formed an adsorption unit 22 for adsorbing and releasing the CD 12 by sucking in and discharging air, and by this air sucking operation, the CD 12 is adsorbed to the tip end of the arm 21 to thereby take it out of the mounting tray 17, and further by an air discharging operation, the CD 12 is released from the arm 21 to thereby mount it on the mounting tray 17.

Also, as shown in FIG. 2, on the surface of this mounting tray 17, a mounting portion 18 for mounting the CD 12 is provided in a circular shape that is a shape of the CD 12, and the surface of this mounting portion 18 is made into such a non-sticking surface 24 that, for example, when the heat roller 15 is press-contacted to the CD 12, prevents the CD 12 from strongly sticking to the mounting portion 18. This non-sticking surface 24 may be formed by stacking, for example, fluoroplastic layers, or may be formed with microscoptic asperities. Thus, even when a force of 300N or more is applied by press-contacting the heat roller 15 to the CD 12 through the intermediate transfer sheet 10, the non-sticking surface 24 is adapted such that a sticking force between the CD 12 and the mounting portion 18 becomes 2N or less.

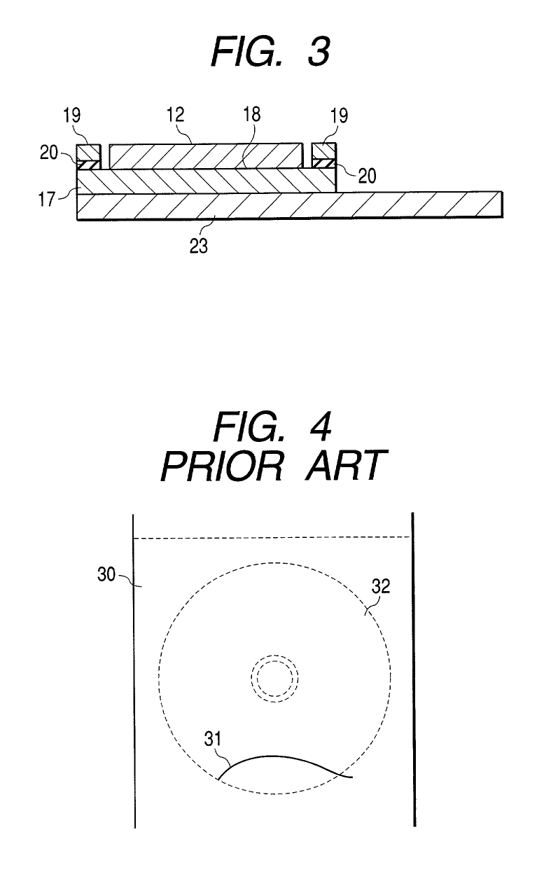

Further, of the surface of this mounting tray 17, on other portions than the mounting portion 18 for mounting the CD 12, there is formed a holding member 19 for holding the peripheral edge of the CD 12. The inner peripheral surface of this holding member 19 is formed in a circular arc shape so as to run along the outer peripheral surface of the CD 12. Further, this holding member 19 is formed in such a manner that when the CD 12 is mounted on the mounting portion 18 as shown in FIG. 3, the surface of the CD 12 is flush with the surface of the holding member 19, whereby when the CD 12 is mounted on the mounting tray 17 to cause the heat roller 15 to descend, the heat roller 15 is adapted to abut upon a surface flush with the surface of the CD 12 and the surface of the holding member 19 of the mounting tray 17 through the intermediate transfer sheet 10. Further, on the lower side of the holding member 19, there is disposed an elastic member 20. In this respect, it is advisable to form the mounting portion 18 of a member having elasticity. Also, the elastic member 20 can be omitted as required.

Next, the description will be made of an operation of the present embodiment.

First, the conveying base 23 is caused to move to a position where the mounting tray 17 is exposed to the outside of the intermediate transfer type printer 1. In this case, the CD 12 is conveyed through the use of the recording medium conveying device 20 and the recording medium conveying device 20 is caused to descend on the upper side of the mounting tray 17. Thus, air is discharged from the adsorption unit 22, whereby the CD 12 is mounted on the mounting portion 18 of the mounting tray 17, and thereafter, the conveying base 23 is caused to move to the transfer unit 14.

Thus, the heat roller 15 heated is caused to descend, and this heat roller 15 is first caused to abut upon one end of the CD 12 through a portion onto which ink of the intermediate transfer sheet 10 has been transferred. At this time, the heat roller 15 abuts upon the surface of the CD 12 and the surface of the holding member 19 which become a surface flush with the surface of the heat roller 15 through the intermediate transfer sheet 10.

Next, the conveying base 23 is caused to move toward the outside of the intermediate transfer type printer 1 such that the entire surface of the CD 12 abuts upon the heat roller 15, and the intermediate transfer sheet 10 is conveyed. At this time, the conveying base 23 and the transfer sheet 10 are moved and conveyed at the same speed.

As a result, the ink temporarily transferred onto the intermediate transfer sheet 10 is caused to melt by means of the heat of the heat roller 15 for retransferring it on the surface of the CD 12 to thereby achieve recording on the surface of the CD 12.

In the present embodiment, the holding member 19 is formed in such a manner that when the CD 12 is mounted on the mounting portion 18, it becomes flush with the surface of the CD 12, and the heat roller 15 abuts upon the surface of the CD 12 and the surface of the holding member 19 which become a surface flush with the surface of the heat roller 15 through the intermediate transfer sheet 10. Therefore, uniform tension is applied on the intermediate transfer sheet 10 in the direction of width thereof.

Therefore, even when the conveying base 23 has been moved while the heat roller 15 remains in the state in which it abuts upon the CD 12 through the intermediate transfer sheet 10, the ink of the intermediate transfer sheet 10 can be retransferred onto the CD 12 without causing any wrinkles to the intermediate transfer sheet 10. As a result, it becomes possible to prevent a failure in retransferring the ink onto the CD 12, and to obtain a high quality image on the CD 12.

Also, on the lower side of the holding member 19, there is disposed an elastic member 20; further, the mounting portion 18 is formed of a member having elasticity; the heat roller 15 softly abuts upon the surface of the CD 12 and the surface of the holding member 19 through the intermediate transfer sheet 10 and the position of the surface can be adjusted, and therefore, it is possible to align the surface of the CD 12 and the surface of the holding member 19 to be further flush with each other. As a result, a higher quality image can be obtained on the CD 12.

Also, in the present embodiment, the recording medium conveying device 20 takes the CD 12 out of the mounting tray 17 by adsorbing it, and the present invention is not limited thereto, but the CD 12 can be taken out by various methods such as holding the CD 12 at the peripheral edge or manually.

Thereafter, the mounting tray 17 is caused to move again to the position where the mounting tray 17 is exposed to the outside of the intermediate transfer type printer 1, and the CD 12 is adsorbed by sucking in air by the adsorption unit 22 through the use of the recording medium conveying device 20, whereby the CD 12 is taken out of the mounting tray 17 and the recording medium conveying device 20 is raised to convey the CD 12.

Also, the non-sticking surface 24 of the mounting tray 17 is formed with a fluoroplastic layer, the surface of fluoroplastic has a low coefficient of friction, and is unlikely to stick. For this reason, when the CD 12 is press-contacted to the mounting tray 17 by the heat roller 15, it is possible to prevent the CD 12 from strongly sticking to the mounting portion 18.

Therefore, even when the CD is taken out of the mounting tray 17 through the use of the recording medium conveying device 20, the CD 12 is adsorbed to the adsorption unit 22 of the recording medium conveying device 20, whereby it can be easily taken out. Also, since the recording medium conveying device 20 can reliably adsorb and hold the CD 12, it is possible to prevent the CD 12 from being damaged when the CD 12 is taken out of the mounting tray 17.

In this respect, as regards surface treatment of the mounting portion 18, it may be constructed by forming microscoptic asperities on the non-sticking surface 24. In this case, since there exists air between the CD 12 and the mounting portion 18, even when the heat roller 15 is press-contacted to the CD 12, there is no possibility that the CD 12 strongly sticks on the mounting portion 18, and the CD 12 can be easily taken out of the mounting tray 17 through the use of the recording medium conveying device 20.

In this respect, in the present embodiment, the holding member 19 is formed on the entire surface of other portions than the mounting portion 18, of the surface of the mounting tray 17, but the present invention is not limited thereto, and it can be formed around the mounting portion 18 and only as far as it is good enough to prevent any excessive tension from being applied to the intermediate transfer sheet 10 when the heat roller 15 is caused to abut upon the surface of the CD 12 and the surface of the holding member 19 through the intermediate transfer sheet 10.

Also, in the present embodiment, the description has been made through the use of the CD 12 as the recording medium, but the present invention is not limited thereto, and it may be possible to record on a recording medium which is not square like the DVD but has a thickness dimension as compared with a sheet and the like.

Further, in the present embodiment, the description has been made of the intermediate transfer type printer 1 using the intermediate transfer sheet 10 as the intermediate transfer body, but for the intermediate transfer body, it maybe possible to use an intermediate transfer drum serving dually as the platen roller 2 and the heat roller 11.

Further, in the present embodiment, as a method for retransferring, onto the CD 12, the ink transferred onto the intermediate transfer sheet 10, the ink has been retransferred onto the CD 12 by melting the ink transferred onto the intermediate transfer sheet 10 by means of the heat of the heat roller 15, but the present invention is not limited thereto, and it may be possible to use, for example, the heat roller 15 as a contact pressure roller for utilizing contact pressure by the contact pressure roller. In this case, such a mechanism that the ink transferred onto the intermediate transfer sheet 10 is press-contacted to thereby retransfer the ink onto the CD 12 will be given.

Also, the present invention is not limited to the above-described embodiment, and it is possible to change in various ways as required.

As described above, according to an intermediate transfer type printer of the present invention, even when the recording medium is taken out of the mounting tray through the use of the recording medium conveying device, the recording medium is adsorbed, whereby it can be easily taken out. Also, since the recording medium conveying device can reliably adsorb and hold the recording medium, it is also possible to prevent the recording medium from being damaged when the recording medium is taken out of the mounting tray.

Also, according to another intermediate transfer type printer of the present invention, since the surface of fluoroplastic has a low coefficient of friction, there is no possibility that the recording medium strongly sticks on the mounting portion, and the recording medium can be easily taken out of the mounting tray through the use of the recording medium conveying device.

Further, according to another intermediate transfer type printer of the present invention, since there exists air between the recording medium and the mounting portion, there is no possibility that the recording medium strongly sticks on the mounting portion, and the recording medium can be easily taken out of the mounting tray through the use of the recording medium conveying device.

Further, according to another intermediate transfer type printer of the present invention, even when the mounting tray has been moved while the retransfer roller remains in the state in which it abuts upon the recording medium through the intermediate transfer sheet, the ink of the intermediate transfer sheet can be retransferred onto the recording medium without causing any wrinkles to the intermediate transfer sheet. As a result, it becomes possible to prevent a failure in retransferring the ink onto the recording medium, and to obtain a high quality image on the recording medium.

Further, according to another intermediate transfer type printer of the present invention, it is possible to align the surface of the recording medium and the surface of the holding member to be further flush with each other. As a result, a higher quality image can be obtained on the recording medium.

What is claimed is:

1. An intermediate transfer type printer, comprising:
a platen roller;
a recording head disposed so as to oppose to the platen roller;
an intermediate transfer body onto which ink of an ink ribbon is transferred by the recording head for forming a primary image;
a retransfer roller for retransferring, onto a recording medium, the primary image formed on the intermediate transfer body; and
a mounting tray for mounting the recording medium disposed so as to oppose to the retransfer roller through the intermediate transfer body on a downstream side of the recording head in a conveying path of the intermediate transfer body, wherein
of a surface of the mounting tray, a surface of a mounting portion for mounting the recording medium is made into a non-sticking surface which, when the intermediate transfer body is press-contacted to the recording medium, prevents the recording medium from sticking to the mounting portion.

2. The intermediate transfer type printer according to claim 1, wherein the non-sticking surface is of a fluoroplastic layer.

3. The intermediate transfer type printer according to claim 1, wherein the non-sticking surface is constructed by forming a surface thereof with microscopic asperities.

4. An intermediate transfer type printer, comprising:
a platen roller;
a recording head disposed so as to oppose to the platen roller;
an intermediate transfer body onto which ink of an ink ribbon is transferred by the recording head for forming a primary image;
a retransfer roller for retransferring, onto a recording medium, the primary image formed on the intermediate transfer body; and
a mounting tray for mounting the recording medium disposed so as to oppose to the retransfer roller through the intermediate transfer body on a downstream side of the recording head in a conveying path of the intermediate transfer body, wherein
of a surface of the mounting tray, in a surrounding portion of a mounting portion for mounting the recording medium, there is formed a holding member for holding a peripheral edge of the recording medium; and
wherein the holding member is formed in such a manner that when the recording medium is mounted on the mounting tray, a surface of the recording medium is flush with a surface of the holding member.

5. The intermediate transfer type printer according to claim 4, wherein on an under surface of the holding member, there is further disposed an elastic member.
